(19) United States
(12) Patent Application Publication
(10) Pub. No.: US 2014/0150973 A1
(43) Pub. Date: Jun. 5, 2014

(54) EPOXY RESIN COMPOSITION AND MANUFACTURING METHOD OF BONDING STRUCTURE

(71) Applicant: DENSO CORPORATION, Kariya-city (JP)

(72) Inventors: Hiroyuki Okuhira, Kariya-city (JP); Akira Takakura, Kariya-city (JP); Hiroshi Katou, Aichi-gun (JP)

(73) Assignee: DENSO CORPORATION, Kariya-city (JP)

(21) Appl. No.: 14/095,122

(22) Filed: Dec. 3, 2013

(30) Foreign Application Priority Data
Dec. 5, 2012 (JP) 2012-266325

(51) Int. Cl. C09J 163/00; B32B 37/12

(52) U.S. Cl. CPC C09J 163/00; B32B 37/1207
USPC 156/330; 525/523

(57) ABSTRACT

An epoxy resin composition includes: epoxy resin as a main component; and diamine having phenylene oxide skeleton indicated by an equation of:

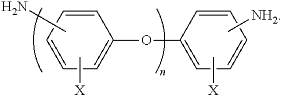

A code of “X” is a hydrogen or a methyl group, and a suffix of “n” is an integer in a range between 1 and 10. In the above composition, the gelation time is short, compared with a case where the epoxy resin composition with using phenylene sulfide skeletal diamine as hardening agent of an epoxy resin.

### CROSS REFERENCE TO RELATED APPLICATION

This application is based on Japanese Patent Application No. 2012-266325 filed on Dec. 5, 2012, the disclosure of which is incorporated herein by reference.

### TECHNICAL FIELD

The present disclosure relates to an epoxy resin composition and a manufacturing method of a bonding structure using an epoxy resin composition as adhesive.

### BACKGROUND

JP-A-S61-183318 teaches an epoxy resin composition with using a phenylene sulfide skeletal diamine as hardening agent of an epoxy resin. The phenylene sulfide skeletal diamine has a chemical formula of Equation No. I.

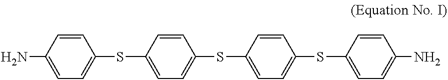 [SMILES: Nc1ccc(Sc2ccc(Sc3ccc(Sc4ccc(N)cc4)cc3)cc2)cc1]

Here, in general, the epoxy resin composition prepared by mixing epoxy resin and hardening agent has high adhesiveness. Thus, the epoxy resin composition is used as epoxy resin adhesive. However, the conventional epoxy resin adhesive has low adhesiveness with poly phenylene sulfide (i.e., PPS), which is engineering plastic material having high heat resistance.

### SUMMARY

It is an object of the present disclosure to provide an epoxy resin composition having gelation time shorter than epoxy resin composition with using phenylene sulfide skeletal diamine as hardening agent. Further, it is another object of the present disclosure to provide a manufacturing method of a bonding structure with using an epoxy resin composition as adhesive, the method providing a stationary arrangement time shorter than a method with using an epoxy resin composition with using phenylene sulfide skeletal diamine as hardening agent of epoxy resin.

According to a first aspect of the present disclosure, an epoxy resin composition includes: epoxy resin as a main component; and diamine having phenylene oxide skeleton indicated by an equation of:

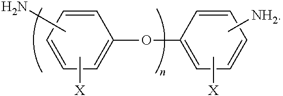

A code of “X” is a hydrogen or a methyl group, and a suffix of “n” is an integer in a range between 1 and 10.

In the above composition, the gelation time is short, compared with a case where the epoxy resin composition with using phenylene sulfide skeletal diamine as hardening agent of an epoxy resin.

According to a second aspect of the present disclosure, a manufacturing method of a bonding structure includes: preparing the epoxy resin composition according to the first aspect; applying the epoxy resin composition to at least one of two adhering objects; bonding two adhering objects; placing bonded two adhering objects without moving; and heating the epoxy resin composition so that the epoxy resin composition is hardened.

In the above method, the gelation time of the epoxy resin composition is short, compared with a case where the epoxy resin composition with using phenylene sulfide skeletal diamine as hardening agent of an epoxy resin. Thus, the stationary placing time is shortened.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a graph showing a DSC measurement results of hardening agent; and

FIG. 2 is a diagram showing evaluation results of various epoxy resin compositions.

### DETAILED DESCRIPTION

The present inventors have studies an epoxy resin composition. As a result of experiments, the epoxy resin composition with using phenylene sulfide skeletal diamine as hardening agent of an epoxy resin has higher adhesiveness with respect to PPS than conventional epoxy resin adhesive. Accordingly, the epoxy resin composition is suitable for adhesive to adhere an object made of PPS.

However, gelation time of the epoxy resin composition may be long. Further, the epoxy resin composition may have the following difficulties.

When two adhering objects are adhered with each other to form an adhering structure (i.e., a bonding structure), and one of the adhering objects is made of PPS, a bonding step and a hardening step are performed. In the bonding step, the epoxy resin composition is applied to at least one of the adhering objects so that two adhering objects are bonded to each other. In the hardening step, the epoxy resin composition is heated so as to be hardened.

Here, after two adhering objects are bonded to each other in the bonding step, the bonded adhering objects are displaced to the hardening step before the epoxy resin composition gelates. In this case, even if the bonded adhering objects are fixed with a jig, the positioning between two adhering objects may be misaligned. Accordingly, after two adhering objects are bonded to each other, the bonded adhering objects are arranged stationary without displacing until the epoxy resin composition gelates.

In the above case, the gelation time of the epoxy resin composition with using the phenylene sulfide skeletal diamine is comparatively long. Thus, the stationary arrangement time is also long. Thus, a process time from the bonding step to the hardening step becomes long. Thus, the epoxy resin composition with using the phenylene sulfide skeletal diamine may not be suitable for a case where the short gelation time is required.

The above difficulties result from not only a case where at least one of two adhering objects is made of PPS but also a case where both of two adhering objects are made of material other than PPS.

The following embodiments describe an epoxy resin composition having gelation time shorter than epoxy resin composition with using phenylene sulfide skeletal diamine as hardening agent. Further, the following embodiments describe a manufacturing method of a bonding structure with using an epoxy resin composition as adhesive, the method providing a stationary arrangement time shorter than a method with using an epoxy resin composition with using phenylene sulfide skeletal diamine as hardening agent of epoxy resin.

The epoxy resin composition according to an example embodiment is prepared by mixing epoxy resin and hardening agent. The hardening agent is made of material including at least diamine indicated by the following general Equation No. II.

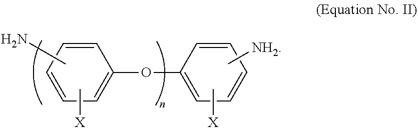

In the Equation No. II, the code “X” represents a methyl group or a hydrogen. The suffix “n” represents integer number between 1 and 10.

The skeleton of the diamine in the Equation No. II has phenylene oxide having a crystal structure similar to PPS shown in the Equation No. III.

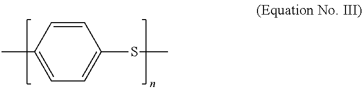

The diamine shown in the general Equation No. II is solid material. When the solid material of the diamine melts, the viscosity of the melted diamine is very low, so that the solubility to general-purpose epoxy resin is excellent.

In the diamine shown in the general Equation No. II, all of benzene rings are coupled at a para position. Alternatively, all of benzene rings may not be coupled at a para position. Alternatively, all of benzene rings may be coupled at a para position through an oxygen atom. Specifically, all benzene rings other than both end benzene rings have the para position, at which the oxygen atom is disposed. In this case, both end benzene rings may have the para position, at which an amino group is disposed. Alternatively, both end benzene rings may have the para position, at which the amino group is not disposed.

An example of the diamine shown in the general Equation No. II is shown as the following Equation No. IV. The diamine in the Equation No. IV is prepared by setting the code “X” in the general Equation No. II to be a hydrogen, setting the suffix “n” to be three, and coupling all of benzene rings at the para position.

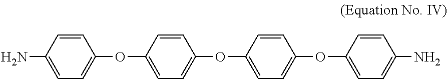 [SMILES: Nc1ccc(Oc2ccc(Oc3ccc(Oc4ccc(N)cc4)cc3)cc2)cc1]

In the diamine in the Equation No. IV, the suffix “n” is equal to or smaller than ten. When the suffix “n” is larger than ten, the solubility to the epoxy resin is reduced, and further, the viscosity of the epoxy resin composition is high even if the diamine solves in the epoxy resin, so that the adhering operation to PPS is deteriorated.

In the diamine in the Equation No. IV, all of the benzene rings are coupled with each other at the para position, the diamine molecule has a planar structure. Thus, the crystallinity of the diamine increases, and the mutual interaction between the diamine molecules also increases. As a result, the physical property such as the strength of the hardened product of the epoxy resin composition and the glass transition temperature (i.e., Tg) increases.

The epoxy resin used in the epoxy resin composition may be in a liquid form. The liquid form epoxy resin is, for example: glycidyl ether type epoxy resin, which is prepared by reacting epichlorohydrin and multivalent phenol such as bisphenol A (i.e., epoxy resin 1 in the first and fourth embodiments), bisphenol F, hydrogen added bisphenol A, and hydrogen added bisphenol F; alicyclic glycidyl ether type epoxy resin, which is prepared based on hydrogen added multivalent phenol; polyglycidyl ether type epoxy resin, which is prepared by reacting epichlorohydrin and fatty polyhydric alcohol such as glycerin, neopentyl glycol, ethylene glycol, propylene glycol, butylene glycol, hexylene glycol, polyethylene glycol, and poly propylene glycol; glycidyl ester type epoxy resin, which is prepared by reacting epichlorohydrin and hydroxy carboxylic acid such as p-hydroxybenzoic acid and β-hydroxynaphthoic acid; poly glycidyl ester type epoxy resin induced from polycarboxylic acid such as phthalic acid, methyl phthalic acid, iso phthalic acid, terephthalic acid, tetrahydro phthalic acid, hexahydro phthalic acid, endo methylene-tetra-hydro phthalic acid, endo methylene-hexa-hydro phthalic acid, trimellitic acid, and polymerized fatty acid; glycidyl amino glycidyl ester type epoxy resin induced from amino phenol, amino alkyl phenol or the like; glycidyl amino glycidyl ester type epoxy resin induced from amino benzoic acid; and softening epoxy resin having a structure made of poly ether, poly urethane, poly carbonate, poly ester, poly acrylic or silicon. These epoxy resins may be used independently or used as a combination of these epoxy resins. Specifically, bisphenol epoxy resin may have excellent physical property and excellent adhesiveness.

Alternatively, solid form epoxy resin may be used as long as the workability is not reduced. The solid form epoxy resin may be bisphenol oligomer type epoxy resin, phenol novolac type epoxy resin, trifunctional phenol derivative type epoxy resin, tetrafunctional phenol derivative type epoxy resin, aralkyl type polyfunctional resin, dicyclopentadiene type epoxy resin, biphenyl type epoxy resin, naphthalene type epoxy resin (i.e., epoxy resin 2 in the second and third embodiments), fluorene type epoxy resin, diphenyl ether type epoxy resin, stilbene type epoxy resin, or the like.

The hardening agent used in the epoxy resin composition may be diamine shown in the general Equation No. II alone. Alternatively, the hardening agent may be a combination of diamine shown in the general Equation No. II and other amine series hardening agents.

The other amine series hardening agents may be a liquid form in order to obtain the liquid form epoxy resin composition easily.

The liquid form amine series hardening agent may be aromatic poly amine such as 3,5-bis(methylthio)-2,4-toluene diamine, 3,5-bis(methylthio)-2,6-toluene diamine, diethyl toluene diamine (i.e., the hardening agent 3 in the third embodiment) and the like.

Alternatively, the liquid form amine series hardening agent may be aliphatic poly amine such as diethylene triamine, tetra ethylene pentamine, and meta xylylene diamine, alicyclic poly amine such as isophorone diamine, 1,3-bis amino methyl cyclohexane, norbornene diamine, and 1,2-diamino cyclohexane, or poly ether skeletal diamine such as polyoxy propylene diamine, polyoxy propylene triamine.

Alternatively, the hardening agent may be a solid form as long as the workability is not reduced. The solid form hardening agent may be amine series hardening agent such as diamino diphenyl methane (DDM), diamino diphenyl sulfone (DDS), dicyandiamide (DICY), and organic acid dihydrazide, or phenol series hardening agent such as novolac type phenol.

The epoxy resin composition according to the present embodiment includes epoxy resin as an organic component, a large amount of which contains in the epoxy resin composition. Thus, the epoxy resin is a main component. The diamine shown in the general Equation No. II may be mixed in the epoxy resin composition with a certain component ratio so that the diamine functions as the hardening agent for the epoxy resin.

For example, when the diamine shown in the general Equation No. II along is used as the hardening agent of the epoxy resin, the epoxy resin and the diamine in the general Equation No. II are mixed such that the equivalent ratio between the epoxy group in the epoxy resin and the NH group in the diamine shown in the general Equation No. II is 1.0, i.e., a ratio between the epoxy group and the NH group is 1:1.

For example, when the diamine shown in the general Equation No. II and the other amine series hardening agent are used as the hardening agent of the epoxy resin, the diamine in the general Equation No. II and the other amine series hardening agent are mixed such that the equivalent ratio between the epoxy group in the epoxy resin and the NH group in a whole of the hardening agent is 1.0, i.e., a ratio between the epoxy group and the NH group is 1:1. In this case, the glass transition temperature Tg of the obtained hardened material increases, and the mechanical property becomes excellent.

Here, when the ratio between the epoxy group and the NH group is 1:1, the epoxy group and the NH group are reacted with each other in just proportion. Alternatively, the equivalent ratio between the epoxy group and the NH group may be different from 1:1 in order to improve the physical property other than the adhesiveness in the epoxy resin composition. For example, the epoxy resin and the hardening agent may be mixed such that the equivalent ratio between the epoxy group and the NH group is in a range between 1:0.5 to 1:2.

The epoxy resin composition according to the present embodiment may include elastomer in addition to the epoxy resin and the hardening agent in order to strengthen the hardened material of the epoxy resin composition. The elastomer may be thermo plastic resin such as poly ether sulfone (PES). Further, the epoxy resin composition according to the present embodiment may include hardening resin other than the epoxy resin and/or a filler.

The epoxy resin composition according to the present embodiment is manufactured by the following method. For example, the liquid form epoxy resin and the solid form diamine shown in the general Equation No. II are mixed, and then, they are heated so as to melt the diamine shown in the general Equation No. II uniformly. Thus, the liquid form epoxy resin composition is formed.

The liquid form epoxy resin composition formed by the above method is used as the adhesive, and two adhering objects are bonded to each other so as to form the adhering structure, one of two adhering objects being made of PPS. The following steps are performed. The liquid form epoxy resin composition is applied to the surface of at least one of two adhering objects, and two adhering objects are bonded to each other. Thus, the bonding step is performed. Then, the bonded two adhering objects are placed without moving until the epoxy resin composition gelates. Thus, the stationary arrangement step is performed. Then, the epoxy resin composition is heated under a certain hardening condition so that the epoxy resin composition is hardened. Thus, the hardening step is performed.

Here, in the diamine in the general Equation No. II, the reactive property of the NH₂ group with respect to the epoxy group increases, compared with the diamine in which the oxygen O is replaced to the sulfur S in the general Equation No. II, since the oxygen O has an electronegativity higher than the sulfur S. Accordingly, the epoxy resin composition according to the present embodiment has a gelation time shorter than the epoxy resin composition with using the phenylene sulfide skeletal diamine. The gelation time is time period from time when the epoxy resin composition is liquefied in order to apply the epoxy resin composition to time when the epoxy resin composition is not adhered to a tool when the tool such as a paddle touches the epoxy resin composition since reaction between the epoxy resin and the hardening agent proceeds. The state that the epoxy resin composition is in the liquid form corresponds to, for example, the state that the liquid form epoxy resin component is manufactured by heating the epoxy resin and the hardening agent, or the state that cooled and solidified epoxy resin composition is liquefied by heating again.

Thus, when the epoxy resin composition according to the present embodiment is used, the stationary arrangement time is reduced, so that the process time from the bonding step to the hardening step is reduced. Here, the gelation time varies with the heating temperature when the epoxy resin composition is liquefied.

The epoxy resin composition according to the present embodiment has strong mutual reaction with PPS when the epoxy resin and the hardening agent are reacted with each other so that the coupling of the epoxy resin is strengthened and hardened, and therefore, the adhesiveness with PPS is excellent, since the skeleton in the hardening agent has the phenylene oxide with a crystal structure similar to PPS.

Here, the above features relate to a case where at least one of two adhering objects is made of PPS. Even when both of two adhering objects are not made of PPS, the epoxy resin composition according to the present embodiment can be used as the adhesive.

The epoxy resin composition according to the present embodiment is used as the adhesive. Alternatively, the epoxy resin composition according to the present embodiment may be used for other purposes. The epoxy resin composition according to the present embodiment may be used for various purposes similar to a conventional epoxy resin composition.

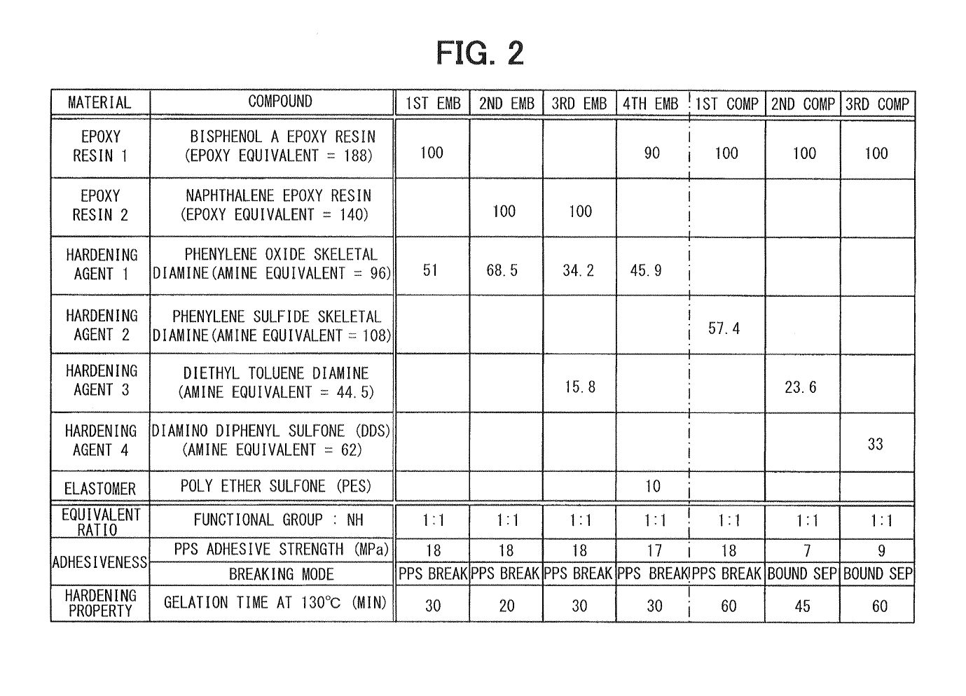

FIG. 2 shows evaluation results of the present embodiments and comparison cases with respect to mixing ratio, the equivalent ratio, adhesiveness and hardening property of the epoxy resin composition. The mixing ratio in FIG. 2 represents a mass ratio.

In the first embodiment, the liquid form epoxy resin No. 1 and the solid form hardening agent No. 1 are mixed according to the mixing ration shown in FIG. 2. These are heated at 130° C., so that the hardening agent No. 1 solves in the epoxy resin No. 1 uniformly. Thus, the epoxy resin composition is obtained. The hardening agent No. 1 is the diamine shown in the Equation No. IV, i.e., phenylene oxide oligomer having an amino group at both ends (i.e., amine terminated phenylene oxide oligomer).

The gelation time of the obtained epoxy resin composition is measured. Further, in addition to the measurement of the gelation time, the obtained epoxy resin composition is applied to the adhering object, and then, the epoxy resin composition is hardened under a certain condition, and the shearing bond experiment is performed.

The epoxy resin No. 1 in the first embodiment is replaced to the epoxy resin No. 2, which is in the solid state at room temperature, so that the epoxy resin composition according to the second embodiment is prepared.

The epoxy resin composition according to the third embodiment is prepared by using the hardening agent No. 1 and No. 3 in the epoxy resin composition according to the second embodiment.

The epoxy resin composition according to the fourth embodiment is prepared by adding the elastomer made of PES into the epoxy resin No. 1 and the hardening agent No. 1 according to the first embodiment.

The epoxy resin composition according to the first comparison is prepared by replacing the hardening agent No. 1 with the hardening agent No. 2 in the first embodiment. The epoxy resin composition according to the second comparison is prepared by replacing the hardening agent No. 1 with the hardening agent No. 3 in the first embodiment. The epoxy resin composition according to the third comparison is prepared by replacing the hardening agent No. 1 with the hardening agent No. 4 in the first embodiment. The hardening agent No. 2 is phenylene sulfide skeletal diamine prepared by the present inventors.

The component material of the epoxy resin composition according to the first to fourth embodiments and the first to third comparisons, the synthesis method of the hardening agents No. 1 and No. 2, the hardening condition of the epoxy resin composition in the shearing bond experiment, and the experimental conditions are described as follows.

(Material)

The epoxy resin No. 1 is the bis phenol A type epoxy resin produced by Dow Chemical Company in Japan. The product name is “DER331J.”

The epoxy resin No. 2 is the naphthalene type epoxy resin produced by DIC Corporation. The product name is “HP-4710.”

The hardening agent No. 3 is diethyl toluene diamine produced by Mitsubishi Chemical Corporation. The product name is “jER CURE W.”

The hardening agent No. 4 is diamino diphenyl sulfone produced by Huntsman Corporation. The product name is “ARADUR 9664-1.”

The elastomer is prepared by smashing material of PES produced by Sumika CHemtex Co., Ltd into pieces having dimensions equal to or smaller than 100 micrometers. The product name is “Sumika Excel 5003PS.”

(Synthesis Method of Hardening Agent No. 1)

NN-dimethyl acetamide is used as reaction solvent, and 4,4′-dihydroxy diphenyl ether and p-chloro nitro benzene are mixed with the equivalent ratio of “OH:Cl=1:1.1.” Then, the temperature is increased to 80° C., and potassium carbonate is added with the equivalent ratio of “OH:Potassium carbonate=1:1.1.” Then, they are reacted with each other for five hours at 125° C. The reaction solution is mixed into ion-exchange water so that reprecipitation is performed, and recipitate is filtered. Thus, solid material is obtained. Further, the solid material is washed in hot methanol, and then, the filtering process is performed. Thus, the filtered solid material is obtained. The obtained solid material is dried, and phenylene ether oligomer having a nitro group at both ends is obtained. Here, the suffix “n” is three, and a yield ratio is 90 percents.

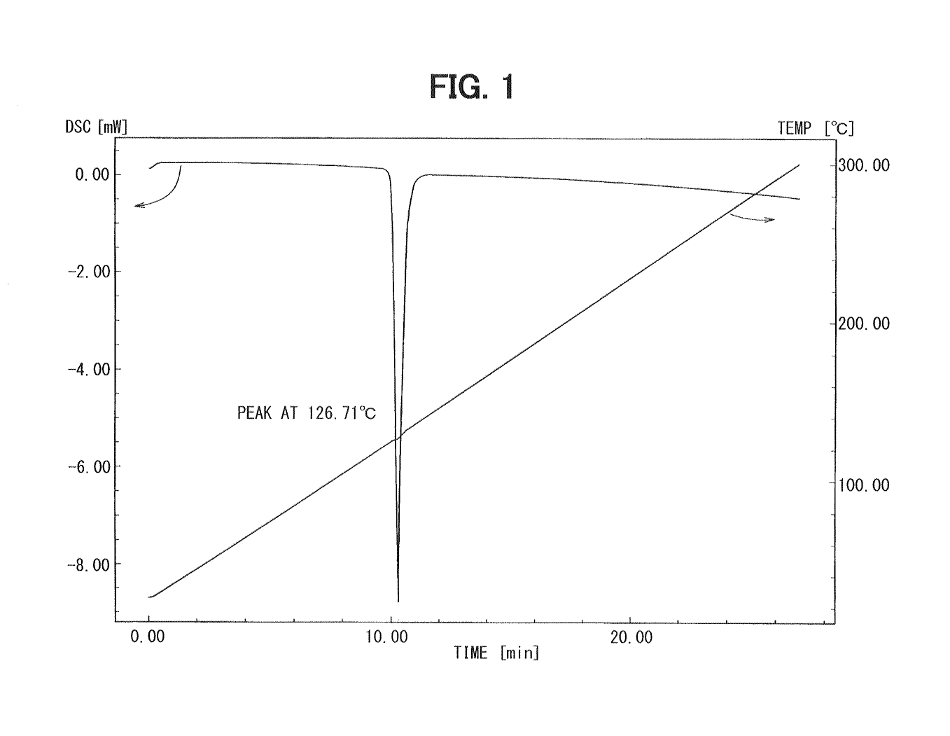

Next, mixed solution of isopropyl alcohol and tetrahydrofuran is used as reaction solvent, and phenylene ether oligomer having a nitro group and palladium carbon are mixed with the mass ratio of “phenylene ether oligomer having a nitro group:palladium carbon=1:0.05.” Then, the temperature is increased to 55° C. Hydrazine hydrates is added with spending one hour, and the equivalent ratio is “nitro group:hydrazine hydrates=1:4.” Further, they are reacted with each other for five hours at 60° C., so that the nitro group is reduced to the amino group. Palladium carbon is removed by filtering under heated condition. Then, vacuum concentration is performed, so that two-thirds of solvent is distilled away. Then, isopropyl alcohol having an amount equal to the distilled solvent is newly added. After temperature is increased to 80° C., they are cooled, so that the solid material is obtained. The solid material is filtered and retrieved, and then, the retrieved solid material is dried. Thus, phenylene ether oligomer having an amino group at both ends is obtained. Here, the suffix “n” is three, and a yield ratio is 85 percents. The differential scanning calorimetry (DSC) measurement of the obtained compound is performed, and the measurement result is shown in FIG. 1. A sharp peak indicative of a melting point of the object is observed around 126° C. Here, although not shown in the drawings, the purity of the compound is confirmed by a high-speed liquid chromatography (HPLC).

(Synthesis Method of Hardening Agent No. 2)

NN-dimethyl acetamide is used as reaction solvent, and dithio diphenylene sulfide and p-chloro nitro benzene are mixed with the equivalent ratio of “SH:CI=1:1.1.” Then, the temperature is increased to 60° C., and potassium carbonate is added with the equivalent ratio of “SH:Potassium carbonate=1:1.1.” Then, they are reacted with each other for five hours at 120° C. The reaction solution is mixed into ion-exchange water so that reprecipitation is performed, and recipitate is filtered. Thus, solid material is obtained. Further, the solid material is washed in hot methanol, and then, the obtained solid material is dried, and phenylene sulfide oligomer having a nitro group at both ends is obtained. Here, the suffix “n” is three, and a yield ratio is 80 percents.

Next, isopropyl alcohol is used as reaction solvent, and phenylene sulfide oligomer having a nitro group and palladium carbon are mixed with the mass ratio of “phenylene sulfide oligomer having a nitro group:palladium carbon=1:0.05.” Then, the temperature is increased to 70° C. Hydrazine hydrates is added with spending one hour, and the equivalent ratio is “nitro group:hydrazine hydrates=1:4.” Further, they are reacted with each other for five hours at 80° C., so that the nitro group at each end is reduced to the amino group. Palladium carbon is removed by filtering under heated condition. Then, vacuum concentration is performed, so that two-thirds of solvent is distilled away. Then, they are cooled, so that the solid material is obtained. The solid material is filtered and retrieved, and then, the retrieved solid material is dried. Thus, phenylene sulfide oligomer having an amino group at both ends is obtained. Here, the suffix “n” is three, and a yield ratio is 75 percents.

(Hardening Condition of Epoxy Resin Composition)

The hardening is performed at 130° C. for one hour, and then, at 180° C. for five hours.

(Shearing Bond Experiment)

The adhering object is made of PPS, and the shearing bond experiment is performed at room temperature according to JIS (Japanese Industrial Standards) K-6850, so that the bonding strength is measured.

The dimensions of the adhering object are such that the length is 100 millimeters, the thickness is 3 millimeters, and the width is 20 millimeters.

The overlapping width is 5 millimeters.

The experimental speed is 5 mm/min.

Further, after performing the shearing bond experiment, the breaking state between the adhering object and the resin composition is observed.

(Regarding the Result in FIG. 2)

As shown in FIG. 2, the epoxy resin compositions in the first to fourth embodiments have gelation time shorter than the epoxy resin composition according to the first comparison.

Further, the shearing bond strength of the epoxy resin composition according to the first to fourth embodiments is about 17 MPa to 18 MPa, which is similar to the epoxy resin composition according to the first comparison. After the shearing bond experiment, PPS is broken, i.e., the base material is broken. On the other hand, the shearing bond strength of the epoxy resin composition according to the second and third comparisons is around 7 MPa to 9 MPa. After the shearing bond experiment, the boundary between the hardened epoxy resin composition and the adhering object is separated, i.e., a boundary separation occurs. Thus, the epoxy resin composition according to the first to fourth embodiments have excellent adhesiveness with respect to PPS, similar to the epoxy resin composition according to the first comparison.

The epoxy resin compositions according to the first to fourth embodiments are prepared based on the diamine shown in the general Equation No. II, and the code “X” is hydrogen, and the suffix “n” is three. Alternatively, the epoxy resin composition may be prepared based on the diamine shown in the general Equation No. II, and the code “X” is methyl group, and the suffix “n” is in a range between 1 and 10 other than 3. In this case, the results similar to the results according to the first to fourth embodiments are obtained.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An epoxy resin composition comprising:
epoxy resin as a main component; and
diamine having phenylene oxide skeleton indicated by an equation of: 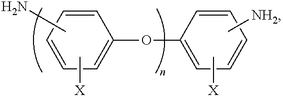
wherein a code of “X” is a hydrogen or a methyl group, and
wherein a suffix of “n” is an integer in a range between 1 and 10.

2. The epoxy resin composition according to claim 1,
wherein all of benzene rings are coupled at a para position.

3. The epoxy resin composition according to claim 1,
wherein the suffix of “n” is three.

4. The epoxy resin composition according to claim 1,
wherein the code of “X” is a hydrogen.

5. The epoxy resin composition according to claim 1, further comprising:
elastomer as thermo plastic resin.

6. A manufacturing method of a bonding structure comprising:
preparing the epoxy resin composition according to claim 1;
applying the epoxy resin composition to at least one of two adhering objects;
bonding two adhering objects;
placing bonded two adhering objects without moving; and
heating the epoxy resin composition so that the epoxy resin composition is hardened.

7. The manufacturing method of the bonding structure according to claim 6,
wherein at least one of two adhering objects is made of poly phenylene sulfide.
